(19) United States
(12) Patent Application Publication
(10) Pub. No.: US 2010/0063714 A1
(43) Pub. Date: Mar. 11, 2010

(54) METHOD FOR DETERMINING TRAFFIC CONDITIONS

(75) Inventor: Nathan John Harrington, Cary, NC (US)

Correspondence Address: IBM CORPORATION (SWP), C/O SUITER SWANTZ PC LLO, 14301 FNB PARKWAY, SUITE 220, OMAHA, NE, 68154-5299, US

(73) Assignee: INTERNATIONAL BUSINESS MACHINES CORPORATION, Armonk, NY (US)

(21) Appl. No.: 12/205,274

(22) Filed: Sep. 5, 2008

(51) Int. Cl. G06G 7/76

(52) U.S. Cl. 701/117

(57) ABSTRACT

The present disclosure is directed towards a method for determining traffic conditions. The method may comprise: detecting a signal, the signal comprising a radio frequency pulse that was emitted from a spark plug firing in an internal combustion engine; measuring a signal count over an interval of time; determining a speed condition based upon the measurement of the signal count, the speed condition comprising at least a speed reduction condition, a speed increase condition, or a no data condition; and displaying the speed condition to a driver.

### TECHNICAL FIELD

The present disclosure generally relates to the field of computer technology, and more particularly to an automobile antenna used for detecting changes in traffic patterns, such as traffic jams or accidents.

### BACKGROUND

Modern vehicles may have positional indicator systems such as radar, lidar, or sonar systems to actively determine the position of other vehicles on the roadway. Vehicles with these indicator systems continually transmit and receive the position of each vehicle's position.

### SUMMARY

The present disclosure is directed towards a method for determining traffic conditions. The method may comprise: detecting a signal, the signal comprising a radio frequency pulse that was emitted from a spark plug firing in an internal combustion engine; measuring a signal count over an interval of time; determining a speed condition based upon the measurement of the signal count, the speed condition comprising at least a speed reduction condition, a speed increase condition, or a no data condition; and displaying the speed condition to a driver.

The present disclosure may be further directed to a completely passive detection system that works for detecting all vehicles with a spark-gap ignition system (nearly all vehicles on the road today). No additional communication or scanning hardware may be required on vehicles as part of the system.

The advantages of this invention are that it requires installation on only one vehicle. Unlike the prior art that requires installation of communication and positional devices on each vehicle, the present disclosure passively detects emissions of nearby vehicles.

The present disclosure may also operate without requiring lines of sight between the vehicle that has the detection system installed and other detected vehicles. The detection system may be capable of providing traffic speed change measurements to vehicles in dense traffic conditions or in traffic conditions with highly limited visibility, such as following behind an eighteen wheel truck.

It is to be understood that both the foregoing general description and the following detailed description are exemplary and explanatory only and are not necessarily restrictive of the present disclosure. The accompanying drawings, which are incorporated in and constitute a part of the specification, illustrate subject matter of the disclosure. Together, the descriptions and the drawings serve to explain the principles of the disclosure.

### BRIEF DESCRIPTION OF THE DRAWINGS

The numerous advantages of the disclosure may be better understood by those skilled in the art by reference to the accompanying figures in which:

FIG. 1 is a block diagram of a detection system; and

FIG. 2 is a flow diagram depicting a method for determining traffic conditions.

### DETAILED DESCRIPTION

Reference will now be made in detail to the subject matter disclosed, which is illustrated in the accompanying drawings.

The present disclosure is directed towards a method for determining traffic conditions. The method may comprise: detecting a signal, the signal comprising a radio frequency pulse that was emitted from a spark plug firing in an internal combustion engine; measuring a signal count over an interval of time; determining a speed condition based upon the measurement of the signal count, the speed condition comprising at least a speed reduction condition, a speed increase condition, or a no data condition; and displaying the speed condition to a driver.

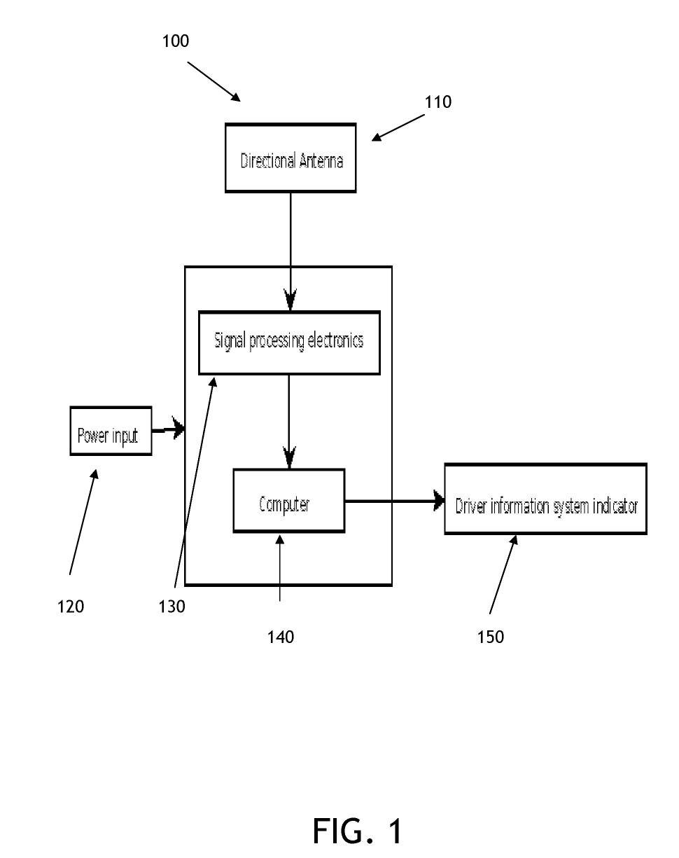

Referring to FIG. 1, a block diagram for a detection system is depicted 100. One possible embodiment of a method 100 may comprise of a directional antenna 110. The method 100 may also comprise signal processing electronics 120. The method 100 may also comprise of a power input. The method 100 may also comprise of a computer 140. The method 100 may also comprise of a driver system indicator 150.

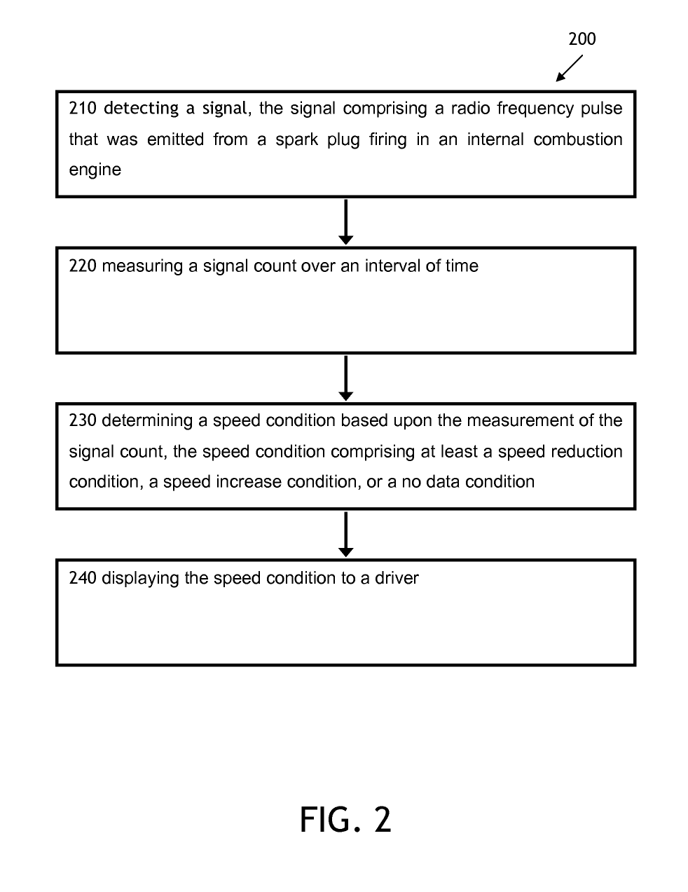

Referring to FIG. 2, a method for determining traffic conditions is depicted 200. Method 200 may be executed by detection system 100 of FIG. 1. The method 200 may detect a signal, the signal comprising a radio frequency pulse that was emitted from a spark plug firing in an internal combustion engine 210. The method 200 may measure a signal count over an interval of time 220. The method 200 may determine a speed condition based upon the measurement of the signal count, the speed condition comprising at least a speed reduction condition, a speed increase condition, or a no data condition 230. The method 200 may display the speed condition to a driver 240.

The preferred embodiment may have an antenna 110 configured to detect signals 210 located directly in front of the antenna 110. The antenna 110 may comprise any type of detector that may monitor Radio Frequency (RF) emissions generated within the preferred spectrum. The preferred spectrum of frequencies to be monitored may be between 30 kilohertz and 30 megahertz.

It is envisioned that the signal processing electronics device 130 will be configured to process only the characteristic “spikes” associated with the RF emissions. Generally, an internal combustion engine that has a spark plug system emits radio frequencies when the electrical spark jumps between electrodes within the combustion chamber, generating a unique RF emission “spike”.

Upon detecting the signals 210, the signal processing electronics device 130 may transmit a series of pulses to the computer 140. The series of pulses may comprise the signals generated by the RF emission. The computer 140 may comprise an electronic system that utilizes logic to make decisions. The computer 140 may receive the series of pulses and count the number of pulses. The series of pulses may be counted or measured over an interval of time 220.

The computer 140 may then determine a speed condition 230 based upon the measurement 220. The computer 140 determines the speed condition by determining if the number of pulses is the same, more than, or less than the number of pulses counted in the previous time interval. If the series of pulses is less than the previous time interval, the computer may determine the speed condition to be a speed increase condition 230. If the series of pulses is more than the previous time interval, the speed condition may be a speed reduction condition 230. If the series of pulses is the same as the previous time interval, the speed condition may be a no data condition 230.

Upon determining the speed condition 230, the computer 140 may send a notification to the driver information system indicator 150. The driver information system indicator 150 may display the speed condition to the driver 240. The display may comprise of a warning light within the dashboard, a Liquid Crystal Display within the dashboard, or the like.

In the present disclosure, the methods disclosed may be implemented as sets of instructions or software readable by a device. Further, it is understood that the specific order or hierarchy of steps in the methods disclosed are examples of exemplary approaches. Based upon design preferences, it is understood that the specific order or hierarchy of steps in the method can be rearranged while remaining within the disclosed subject matter. The accompanying method claims present elements of the various steps in a sample order, and are not necessarily meant to be limited to the specific order or hierarchy presented.

It is believed that the present disclosure and many of its attendant advantages will be understood by the foregoing description, and it will be apparent that various changes may be made in the form, construction and arrangement of the components without departing from the disclosed subject matter or without sacrificing all of its material advantages. The form described is merely explanatory, and it is the intention of the following claims to encompass and include such changes.

1. A method for determining traffic conditions, the method comprising:
detecting a signal of a first vehicle and at least one other vehicle by a passive detection system, the signal comprising a radio frequency pulse emitted from a spark plug firing in an internal combustion engine, wherein the passive detection system is installed in the first vehicle;
measuring a signal count over an interval of time;
determining a speed condition based upon the measurement of the signal count, the speed condition comprising at least a speed reduction condition, a speed increase condition, or a no data condition; and displaying the speed condition to a driver of the first vehicle.
